(19) United States
(12) Patent Application Publication
(10) Pub. No.: US 2017/0091726 A1
(43) Pub. Date: Mar. 30, 2017

(54) LOW BANDWIDTH CRYPTO CURRENCY TRANSACTION EXECUTION AND SYNCHRONIZATION METHOD AND SYSTEM

(71) Applicant: NXT-ID, Inc., Shelton, CT (US)

(72) Inventors: Charles Morgan, Katy, TX (US); Andrew Tunnell, Palm Bay, FL (US); David Tunnell, Melbourne, FL (US)

(21) Appl. No.: 15/259,023

(22) Filed: Sep. 7, 2016

Related U.S. Application Data
(60) Provisional application No. 62/215,066, filed on Sep. 7, 2015.

(51) Int. Cl. G06Q 20/10; G06Q 20/36; G06Q 20/38

(52) U.S. Cl. CPC G06Q 20/102; G06Q 20/382; G06Q 20/36; G06Q 2220/00

(57) ABSTRACT

A method for synchronizing a crypto-currency balance ledger stored on a device with data from the associated public crypto-currency block chain. The method comprises receiving from the public block chain data related to incoming transactions as limited to unspent transaction outputs (UTXOs), receiving from the public block chain data related to outgoing transactions that are conducted within a predetermined time frame as determined by a user, and determining whether the data received matches a current balance ledger as stored on the device; and if a match is not indicated updating the current balance ledger to generate an updated balance ledger.

### CROSS REFERENCE TO RELATED APPLICATIONS

This patent application claims the benefit of U.S. provisional patent application filed on Sep. 7, 2015 and assigned Application No. 62/215,066, which is incorporated herein in its entirety.

### FIELD OF THE INVENTION

The present invention relates generally to data synchronization. More particularly, the present invention relates to a low-bandwidth, power-saving solution for crypto currency transaction execution and data synchronization with a public block chain as performed on a mobile or wearable device or IoT device that has intermittent network connectivity.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

A crypto-currency is a virtual currency that uses cryptography for security, making it difficult to counterfeit while allowing for nearly anonymous financial transactions between two parties using cryptographic hashes. Crypto-currency is not issued by a central authority, theoretically rendering it immune to interference or manipulation. The primary drawbacks are theft of the private key that protects the crypto-currency wallet (allowing the thief to assume control of the associated crypto-currency “wallet”) and the loss of the private key due to a software or hardware failure (thereby rendering the crypto-currency “wallet” orphaned and its contents irretrievable by anyone).

Crypto-currency value transferred to a person or business is not locked to or associated with that person or business; it is only locked to or associated with the private cryptographic key held by that person or business.

Crypto-currencies rely upon a public transaction database known as a “Block Chain” which is shared by all nodes participating in a network-based system that is built using the specific crypto-currency protocol. A full copy of the crypto-currency's block chain contains every transaction ever executed in that currency. With this information, anyone can determine the value held by each address at any point in the history of the crypto-currency as well as validate the authenticity of each of those transactions.

Every block contains the hash of the previous block, thereby creating the effect of a chain of blocks going back to the genesis block that contains the initial coin allotment when the currency was first created. Transaction security and immutability are provided by the mechanism of once a block has been in the chain long enough for a few new blocks to be added after it, modification is computationally impractical as all the blocks after the block being modified would also have to also be recalculated. On average, and by design, one (1) block is solved and added to the Block Chain every ten (10) minutes.

Users of crypto-currencies rely on wallets to manage their private cryptographic key, monitor their balances, generate transactions, generate public addresses for receiving payments, and manage the mapping between human-readable labels and payment addresses. Most wallet management software synchronizes the full block chain to the device it is running on for the associated crypto-currency, validating each transaction as its local block chain is updated.

At the time this document was first authored (September 2015), the public block chain for the Bitcoin crypto-currency exceeded 30 GBytes of data and can take days to weeks to synchronize even on a machine with a fast Internet connection and CPU. By the filing of this application (September 2016), the block chain for the Bitcoin crypto-currency exceeds 50 GBytes of data, and growing. This type of data synchronization is impractical for a mobile device due to the impact on battery life, storage space, and processing power required to validate all of the transactions.

Users can create what is known as an “offline” wallet that does not have the same processing requirements of a normal “online/connected” wallet. However, these offline wallets suffer from the requirement to complete, potentially error prone, manual updates to check balances, get transaction statuses, initiate a new transaction, and often require using a complex challenge-response interaction between the payor and payee for each transaction. One positive side-effect of an offline wallet is that it makes theft of the associated private cryptographic key extremely difficult for an attacker without physical access to the storage medium that contains the key.

Although numerous patents and published patent applications exist related to this technology, the present embodiment of the system and method is novel and substantially different in a plurality of elements, thus rendering the embodiment unobvious to a person skilled in the art.

Examples of relevant prior art include:

US published patent application 20150100475 entitled, “System and Method for Managing Payday Accounts Over a Mobile Network” allows for synchronizing an individual's account information across mobile devices for the purpose of payday account management, loan requests, loan payments, and check cashing approval for conventional currencies and account types (e.g. checking, savings, credit, etc.).

US published patent application 20150046337 entitled, “Offline Virtual Currency Transaction” discusses a method for performing offline virtual currency transactions by converting a selectable amount of the virtual currency into a QR-Code, containing encrypted information, that is then directly transmitted to the payee's smart device via infrared, sonic-wave, or an ad-hoc Wi-Fi™ network where it is decrypted and the virtual currency value is added to the payee's balance without validating that the payor actually had ownership of the value transferred to the payee.

US published patent application 20150088721 entitled, “Digital Transactional Procedures and Implements” discloses general procedures referring mainly to the distribution of responsibility in respect to minting digital money into a physical form factor, distribution of that physical embodiment of the digital currency, and trading of that digital currency.

US published patent application 20120109672 entitled, “Transactional Services” discusses, in exceptionally broad terms, the obvious flow of data transactions between a device requesting a service or information from a second device using a challenge-response method for the verification of the identity of the requesting device. The inventor of this service seeks to provide a universal electronic transaction facility that covers all possible data transactions.

U.S. Pat. No. 8,650,434 entitled “System and Methods for Securing Data in Motion” discusses the use of logging and data journaling during data storage operations and transfers between machines as a way of preventing data loss when the destination of the data cannot be written to. Once the data destination becomes available for writing, the journal and or log are processed and the data is delivered to the originally intended destination storage location. The journaling service can also be used to repair data when the integrity of that data is uncertain.

U.S. Pat. No. 8,442,919 B2 entitled “Token Based New Digital Cash Protocols with Combined Blind Digital Signature and Pseudonym Authentication” describes methods for transaction processing and tracking using blind cryptographic signatures to secure the transaction and provide anonymity for conventional currency transactions.

U.S. Pat. No. 8,041,644 entitled “Cryptographic Module for Secure Processing of Value-Bearing Items” discusses a system and method for validating transactions related directly to postage for the United States Postal Service and does not encompass other financial transactions.

U.S. Pat. No. 8,027,926 entitled “Secure and Recoverable Database for On-Line Value-Bearing Item System” describes a design for a system that is capable of containing account in formation in a secure database format that can be recovered in the event of data corruption caused by transmission errors, storage medium failure, or tampering. The patent explicitly focuses how the design could be used to protect data for postage meters and computer printed postage stamps.

U.S. Pat. No. 7,093,127 B2 entitled “System and Method for Computer Storage Security” discusses a method and system for periodic verification of one computer to another when they are transferring data between each other. Verification of the remote computer is determined during a handshake process that occurs within a specific time period after being requested by the local computer.

U.S. Pat. No. 5,231,666 entitled “Cryptographic Method for Updating Financial Records” discusses a cryptographic method for implementing and electronic purse consisting of the conventional-currency account records for a group of member financial institutions and even more particularly the transaction-driven process of updating the electronic purse. The inventor outlines the use of a tree-based hash system to validate the content records that are stored outside of the purse and a block chain hash that proves the validity of changes to the data contained within the purse against the previous values of that data in the purse.

### SUMMARY OF THE INVENTION

Embodiments of the present invention disclosed herein describe methods and systems whereby an electronic crypto-currency wallet device or crypto-currency application running on a mobile and/or wearable device can be synchronized (kept up-to-date) with the public block chain for the associated crypto currency and requires only a condensed storage format for the crypto-currency data on the device.

The system and method disclosed within this document alleviate certain issues associated with use of an offline wallet while still providing a high level of security for the wallet's private cryptographic key for transactions on a mobile and/or wearable device.

These issues addressed by the present invention include, but are not limited to; keeping the validated wallet balance up to date, tracking recent transactions and their validation status, announcing outgoing transactions to the public block chain in a timely manner, providing a data synchronization method that requires very little network bandwidth, providing a local data storage format that has a small memory requirement, providing data error detection that requires minimal processing power, and completely removing the need for manual challenge-response interactions between parties.

Note that the novel technique whereby a method of the present invention seamlessly condenses the relevant crypto-currency information from the block chain and synchronizes it to the device, provides multiple advantages including, but not limited to; reduced storage requirements on the device, reduced network bandwidth requirements, data integrity checks, crypto-currency transaction validation, and low CPU usage directly resulting in lower battery consumption.

In addition, the present invention is specifically designed to take advantage of the multiple transmission capabilities (e.g. NFC (near-field communications), Wi-Fi™, Bluetooth™, private area network (PAN), peer2per networks, point2point communications, radio frequency (RF) communications, RFID (Radio Frequency Identification), acoustic, optical, etc.) available on the host device in order to further reduce bandwidth, CPU, and battery requirements.

### BRIEF DESCRIPTION OF THE DRAWINGS

The skilled artisan will understand that the drawings, described below, are for illustration purposes only. The drawings are not intended to limit the scope of the present invention in any way.

FIG. 1 illustrates the general, non-limiting scope of the invention in which a Crypto-Currency Wallet (100) on a smart device (such as a wearable device or a smart phone) synchronizes information with the Crypto-Currency Public Block Chain (102) via the Internet (101).

FIG. 2 shows a non-limiting example of the communication flow for a Crypto-Currency Wallet (100) that is not on the same network as a Crypto Wallet Synchronization Server (103) and that must use a communication channel through the public Internet (101) (as a non-limiting communication path) to interact with the Public Block Chain (102) via the Crypto Wallet Synchronization Server (103).

FIG. 3 shows a non-limiting example of the communication flow for a Crypto-Currency Wallet (100) that is on the same network as the Crypto Wallet Synchronization Server (103) which in turn is able to retrieve information about the Public Block Chain (102) via the Internet (101).

FIG. 4 illustrates a non-limiting overview of how the current Crypto Wallet Balance (107) comprises the value from previous Transaction Outputs (106) that were sent to the Crypto Wallet (100). These Transactions Outputs are entered into the Balance Ledger (104) which is then used to generate a Status Packet (105) that is then sent to the Crypto Wallet (100) to determine if synchronization is required.

FIG. 5 shows a non-limiting example of the Balance Ledger Creation Process (108), explaining how information from the Public Block Chain (102) can be processed into a Balance Ledger (104) that is used directly by the Crypto Wallet.

FIG. 6 displays a non-limiting example of how data from the Public Block Chain Data Format (109) can be condensed into a smaller Transaction Data Format (110) thereby reducing data storage requirements.

FIG. 7 shows a non-limiting example method of calculating a Merkel-Root hash (111) for an odd-number of inputs from the Balance Ledger (104) entries.

FIG. 8 shows a non-limiting overview of the Transaction Ledger synchronization process and includes the ability to use both push notifications or data polling by the Crypto Wallet to determine when updated information is available for synchronization with the Public Block Chain Parser (102) via an internet or LAN/WAN (101) connection, as a non-limiting communication examples.

FIG. 9 shows a non-limiting overview of outgoing transactions starting with the Unspent Transaction Output (UXTO) (106) entities, consolidating the required entries along with the payment information into the Transaction Request (112), then signing the request with the private cryptographic key, then finally delivering the transaction to the Public Block Chain (102) via the Internet (101) and the crypto-currency network.

FIG. 10 shows a non-limiting overview of the general process for a user to initiate a transaction using crypto-currency.

FIG. 11 shows a non-limiting example of the format for a crypto currency transaction request. This format is dictated by the crypto-currency standards and is only shown here for reference to the information it contains, the complexity behind generating the transaction request, and the necessity for automatically generating the transaction request.

FIG. 12 shows a non-limiting example of the data storage formats for the various information that needs to be stored on the crypto wallet device including examples for, but not limited to: Transaction Data Format for Unconfirmed Transactions (113); Transaction Data Format for Confirmed Transactions (114); Address Book Format (115); and the Balance Ledger Format (116)

### DETAILED DESCRIPTION OF THE INVENTION

Embodiments of the present invention are best understood by reference to the detailed figures and description set forth herein.

Embodiments of the invention are discussed below with reference to the figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention.

Also, singular words should be read as plural and vice versa and masculine as feminine and vice versa, where appropriate, and alternative embodiments do not necessarily imply that the two are mutually exclusive. It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention.

It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although claims to particular combinations of features will be developed, it should be understood that the scope of the disclosure of the present invention also includes any novel feature or any novel combination of features disclosed herein either explicitly or implicitly or any generalization thereof, and whether or not it mitigates any or all of the same technical problems as does the present invention.

Features, that are described in the context of separate embodiments, may also be provided in combination in a single embodiment. Conversely, various features, which are for brevity, described in the context of a single embodiment, may also be provided separately or in any suitable sub-combination. The Applicants hereby give notice that new claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, however, in some instances they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include non-limiting examples such as: a computer; a stationary and/or portable computer; a mobile device; a wearable device; an IoT (Internet of Things) device; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to but is not limited to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to but is not limited to any storage device used for storing data accessible by a computer. Non-limiting examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to, but is not limited to, a system having one or more computers, where each computer may include a computer-readable medium embodying software to operate the computer or one or more of its components. Non-limiting examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); private area networks (PAN); peer2peer network; point2point communications; and a combination of networks, such as an internet and an intranet.

Exemplary networks may operate with any of a number of protocols, such as Internet protocol (IP), transmission control protocol (TCP), asynchronous transfer mode (ATM), and/or synchronous optical network (SONET), user datagram protocol (UDP), IEEE 802.x, near field communication (NFC), Bluetooth™, Wi-Fi™, LoRa™, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein. In the following description and claims, the terms “computer program medium” and “computer readable medium” may be used to generally refer to media such as, but not limited to, removable storage drives, a hard disk installed in hard disk drive, or the like. These computer program products may provide software to a computer system. Embodiments of the invention may be directed to such computer program products.

An algorithm as referred to herein is generally considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

The invention described herein consists of a system and method to parse, condense, synchronize and store data (e.g., as related to a public block chain) related to transactions for associated with a crypto-currency wallet on a mobile device or a wearable device. Advantageously, the invention uses a fraction of the network bandwidth, CPU (computer processing unit) processing power, and storage space as compared to those resources required to keep a conventional crypto-currency wallet synchronized.

The fundamental building block of a crypto-currency transaction is an unspent transaction output, or UXTO. UXTO's are indivisible chunks of crypto-currency locked to a specific owner, recorded on the block chain, and recognized as currency units by the entire network. A UXTO worth 2.5 coins cannot be split into two UXTOs worth a total value of 2.5 coins. The crypto-currency network tracks all available (unspent) UXTOs, currently numbering in the millions.

Whenever a user receives crypto-currency, that amount is recorded within the block chain as a UXTO held by the user, i.e., unspent crypto currencies. Thus, a user's crypto-currency might be scattered as UXTOs amongst hundreds of transactions and hundreds of blocks. In effect, there is no effective “stored balance” of a crypto-currency wallet; there are only scattered UXTOs, locked to specific owners.

An UXTO may have an arbitrary value denominated as a multiple of satoshis (1-satoshi=1/100,000,000 crypto-currency coin). (Other crypto currencies may use a different base value.) Just like dollars can be divided down to two decimal places as cents, crypto-currency can be divided down to eight decimal places as satoshis. Although an UXTO can be any arbitrary value, once created it is indivisible just like a physical coin that cannot be cut in half. If a UXTO is larger than the desired value of a transaction, it must still be consumed in its entirety and change must be generated in the transaction. In other words, if one has a 20-BTC (20 bit coins) UXTO and wants to pay 1-BTC (one bitcoin, as a non-limiting example), the transaction must consume the entire 20-BTC UXTO and produce two outputs: one paying 1-BTC to the desired recipient and another paying 19-BTC in change back to the holder of the 20-BTC UXTO or back to his wallet. As a result, most crypto-currency transactions will generate change.

The UXTOs consumed by a transaction are called transaction inputs (also referred to as incoming transactions), and the UXTOs created by a transaction are called transaction outputs (also referred to as outgoing transactions). In this way, chunks of crypto-currency value move forward from owner to owner in a chain of transactions consuming and creating UXTOs. Transactions consume a UXTO by unlocking it with the signature of the current owner and creating a UXTO by locking it to the bitcoin address of the new owner.

After a transaction is broadcast to the Bitcoin network, as a non-limiting example, it may be included in a block that is published to the network. When that happens it is said that the transaction has been mined at a depth of 1 block. With each subsequent block that is created, the block depth is increased by one.

To ensure against double spending of a bit coin, a transaction should not be considered secure or confirmed until it is a certain number of blocks deep. The classic bitcoin client will show a transaction as “n/unconfirmed” until the transaction is 6 blocks deep. Merchants and exchanges who accept bitcoins as payment can and should set their own threshold as to how many blocks are required until funds are considered confirmed.

There is nothing special about the default, often-cited figure of 6 blocks. It was chosen based on the assumption that an attacker is unlikely to amass more than 10% of the hash rate, and that a negligible risk of less than 0.1% is acceptable. Both these figures are arbitrary, however; 6 blocks are overkill for casual attackers, and at the same time powerless against more dedicated attackers with much more than 10% hash rate.

Due to the way transactions are added to the block chain, it is unnecessary to perform locally any of the hashing and matching calculations used to verify the transactions in the block chain. The sum of the number of blocks that appear in the block chain after a transaction, plus the block the transaction was recorded in, indicates the confirmation count for that transaction.

As described above, a transaction is not considered secure until it is, for example, six blocks deep. For example, if four (4) blocks have been added to the block chain since a transaction was added to the block chain, the confirmation count would equal five (5)→1-original-block+4-new-blocks=5-confirmations. This value may or may not be sufficient to consider the transaction confirmed according to the nature of the transaction and the parties involved in the transaction.

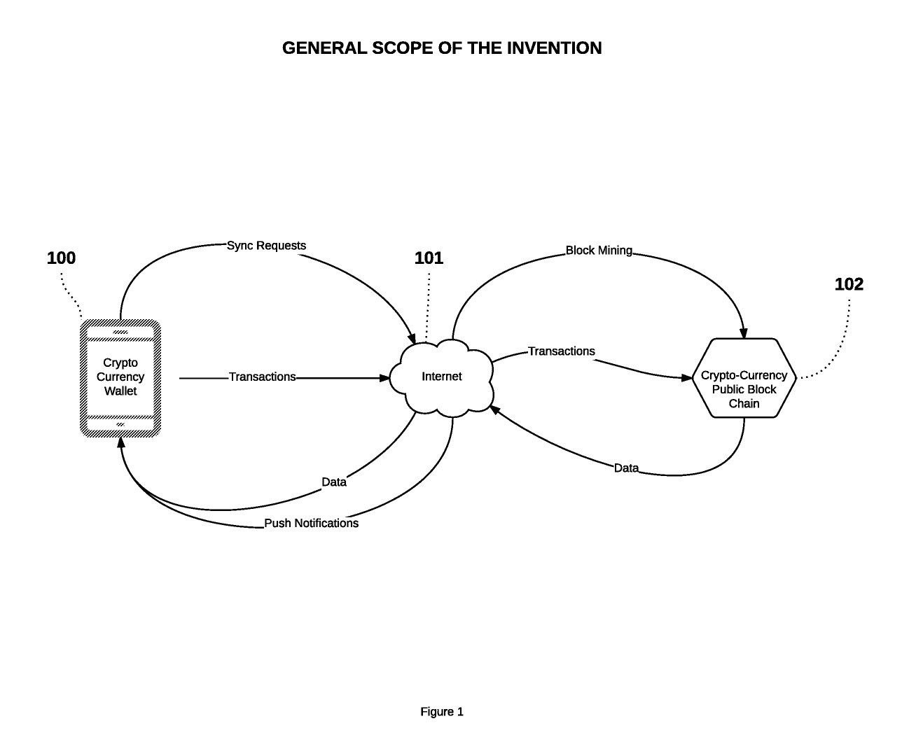

In a non-limiting embodiment, FIG. 1 shows an overview of how the synchronization process disclosed in the current invention is designed such that the process can utilize either polling by the crypto-currency wallet (100) on a mobile device or a push notification. In certain embodiments, push notifications to the mobile are capable of starting the actual data update process on the crypto-currency wallet device. During the synchronization process, data from the public block chain (102) that is associated with the crypto-currency wallet (100) is retrieved from the Internet (101) via a crypto-wallet synchronization server.

Transactions can be conducted from the crypto currency wallet (100) through the internet (101) and eventually are added to the public block chain (102).

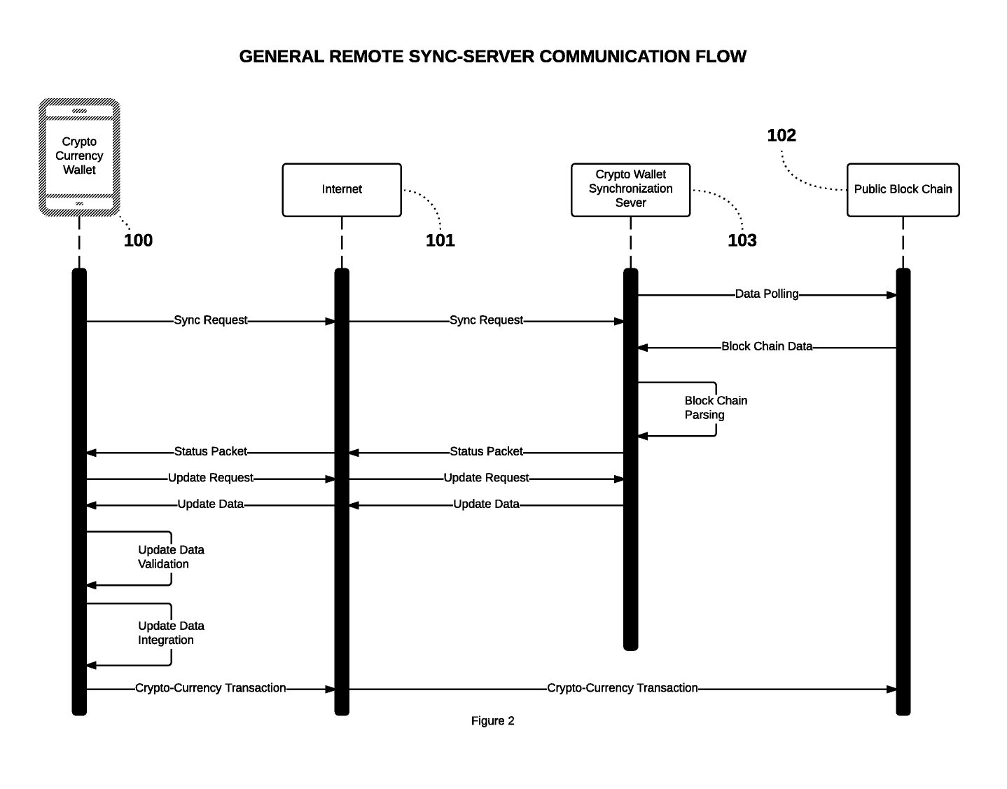

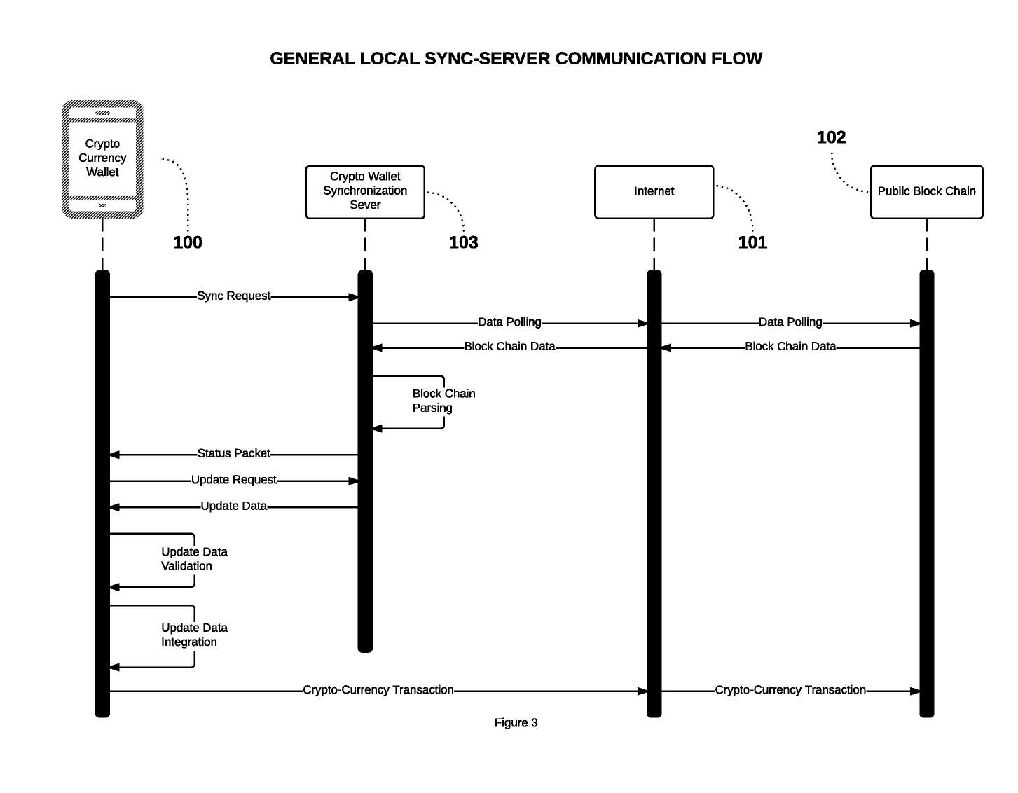

FIG. 2 and FIG. 3 illustrate the non-limiting embodiments of the synchronization process wherein the mobile device containing the crypto-currency wallet is either on the same Local-Area-Network (LAN) as the synchronization server, or in other embodiments, connected to a remote network and/or communication path.

FIG. 2 gives an overview of how the crypto-currency wallet (100) would use a connection to the Internet (101) to communicate with the Crypto-Wallet Synchronization Server (103). The synchronization server (103) queries the Public Block Chain (102) via the Internet (101).

FIG. 3 shows an example of how the crypto-currency wallet (100) could directly connect to the Crypto Wallet Synchronization Server (103) when on the same LAN, for example.

In both FIGS. 2 and 3 the block chain data is parsed and a status packet responsive thereto is sent back to the crypto-currency wallet 100 where it is compared with the data on the wallet. If there is a mismatch, update information is requested and received, validated and integrated with the data stored on the wallet. A crypto-currency transaction can be conducted from the wallet 100.

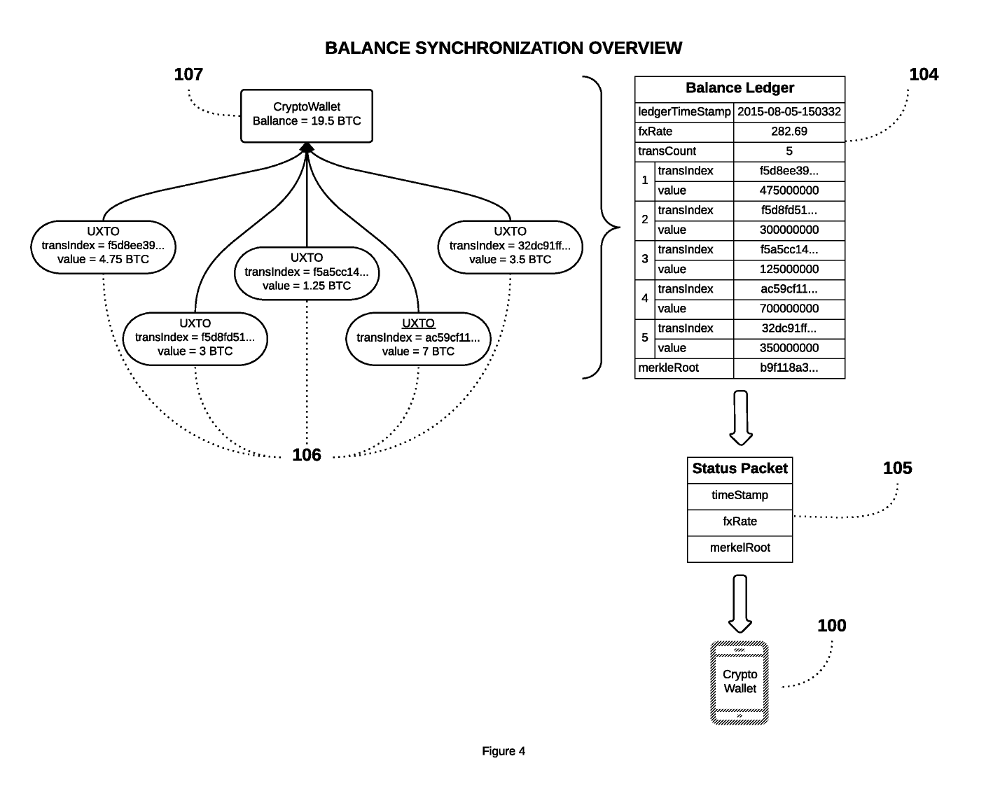

FIG. 4 shows a general, non-limiting overview of generating the Status Packet (105) and the Balance Ledger (104), which is actually a combination of the previous incoming UXTOs (106) delivered by the synchronization process. The total of the value of all of these UXTOs (106) is the Crypto Wallet Balance (107). Note that the current crypto-currency exchange rate (FX-Rate) can be transmitted in the Status Packet (105) so that the user is aware of the actual conventional currency value (e.g. value in USD, etc.) of their crypto wallet in the event they wish to conduct a transaction using the crypto currency.

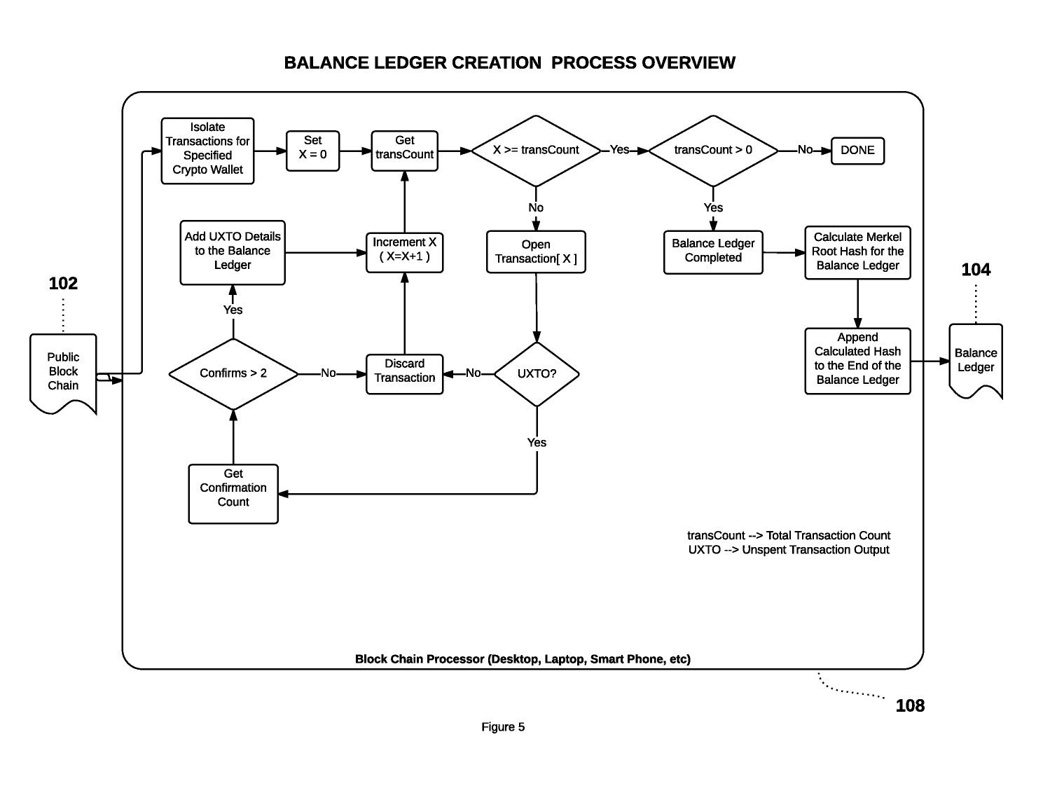

FIG. 5 describes a non-limiting process flow for creating the Balance Ledger (104) from the Public Block Chain (102). The Balance Ledger (104) contains the current, verified total balance of the crypto-currency wallet and the underlying transaction information required to use that crypto-currency value in future transactions. In this Block Chain Processor (108), the UXTOs for a specific crypto-currency wallet are isolated and extracted from the Public Block Chain (102). The confirmation count present in the incoming transactions is observed, and only transactions with two (2) or more confirmations are added to the Balance Ledger (104). Once all of the UXTOs have been added to the Balance Ledger (104), a Merkel-Root-Hash is calculated, based on information contained in those UXTOs, and appended to the end of the Balance Ledger (104). The Merkel-Root-Hash serves as a checksum for the ledger.

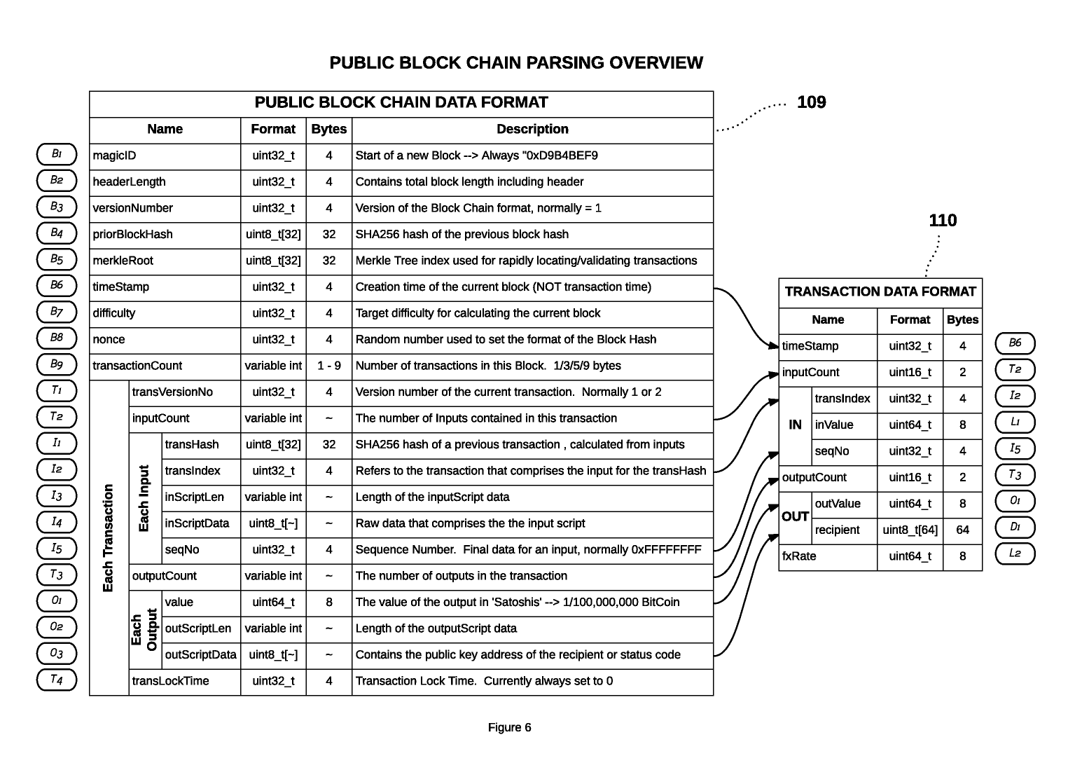

FIG. 6 illustrates a non-limiting example of reducing the information stored in the Public Block Chain Data Format (109) to the Transaction Data Format (110) that is stored on the crypto-currency wallet on the mobile device. By limiting the data needing to be stored to only pertinent information in a fixed format, the storage space requirements on the device are greatly reduced.

The elements of the transaction data format comprise:

Timestamp: This is the time and date that the block, which contains this transaction, was created. The format of the timestamp is Epoch format which is a widely used format for storing dates and times
inputCount: The number of inputs (UXTOs) contained in this transaction. This value is used primarily for parsing the “IN” values.
IN→transIndex: This is the index of the transaction. This “value” came from and requires less storage space than storing the entire transHash from that transaction.
IN→inValue: This is the value of this incoming UXTO as determined/parsed from the inScriptData.
IN→seqNo: The final data for in input (normally 0xffffffff) and is used in this case to ensure separation between input transactions (it serves as a divider line between multiple UXTO inputs into a single transaction).
OutputCount: The number of recipients to receive payment from this transaction (this will almost always be 2 unless you are sending someone a payment [plus the processing fee] that just happens to exactly match an incoming UXTO).
OUT→outValue: The amount/value being sent to the recipient.
OUT→recipient: The public key address, or identifier, of the recipient.
fxRate: The average exchange rate for the crypto-currency against the local federal currency (US Dollar, Yen, etc.)

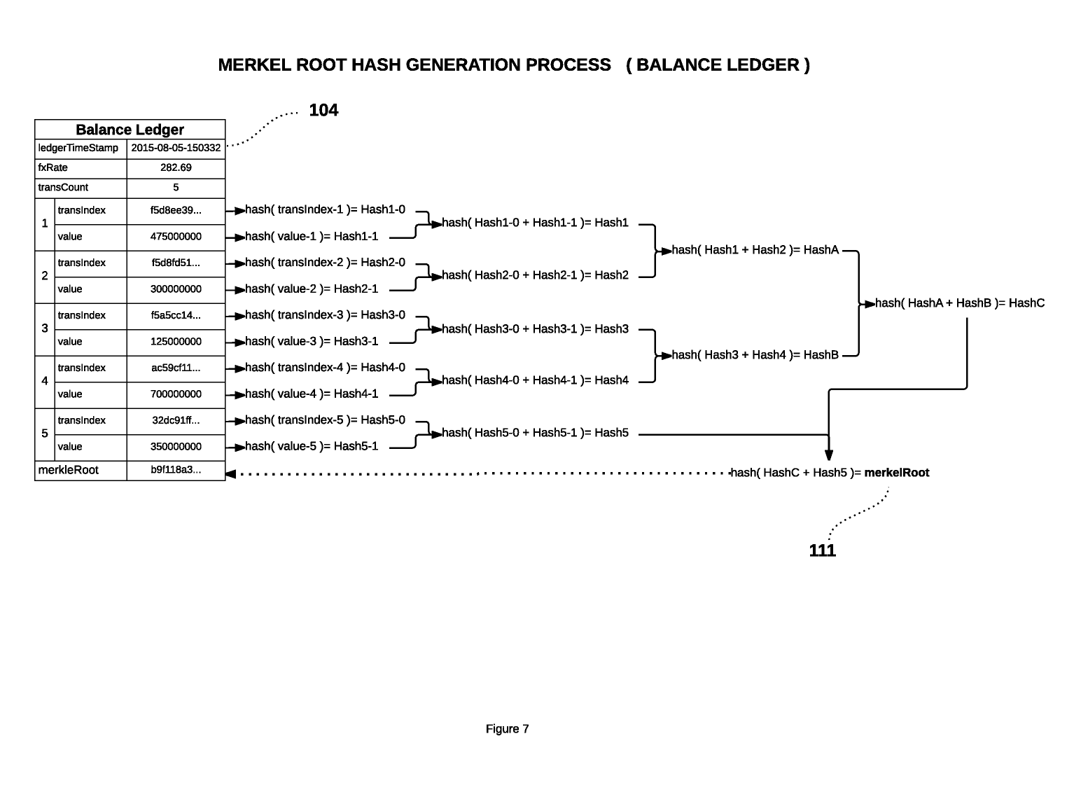

FIG. 7 shows, for illustration purposes only, how a Merkel Root Hash is calculated. In this example an odd number of inputs (transactions) are used and the last transaction is not doubled-up, as is often done to create an even number of inputs, as there is not a benefit to the integrity of the resulting hash due to performing the extra hashing calculation.

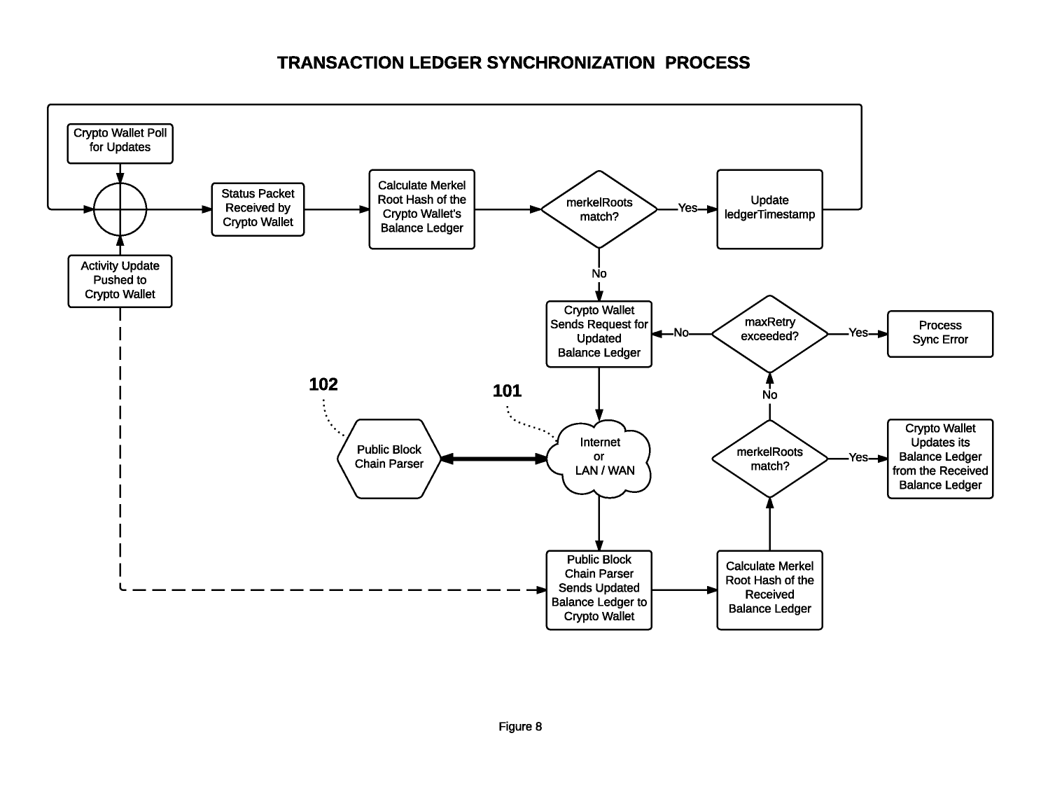

FIG. 8 shows a non-limiting overview of the synchronization process for the Balance Ledger wherein the crypto-currency wallet, in different embodiments, can either poll for updates or receive push notifications of updates. Both methods have advantages and have different impacts on bandwidth requirements and power consumption.

When a status packet is received by the crypto-currency wallet, either through polling or a push notification, the crypto-currency wallet calculates or looks-up the Merkel Root Hash of its current Balance Ledger and then compares it to the Merkel Root Hash on the status packet. If the hashes match, no update of the balance ledger is required, however the FX Rate stored on the device can still be updated from the status packet.

If the hashes do not match, the device sends a request to the synchronization server for an updated Balance Ledger.

When the updated ledger is received, the Merkel Root Hash is calculated on the device for all of the transactions in the ledger. If it matches the hash included in the ledger and the hash from the status packet, then the Balance Ledger on the device is updated. If any comparison fails, the Balance Ledger is re-requested from the Block Chain Parsing Server up to a defined maximum number of retry attempts. If the maximum retries is exceeded, the synchronization fails with a notification to the user.

Based on a configuration value, the entire synchronization process would restart after a defined waiting period. For the synchronization process to function, there must be connectivity between the mobile device and the Block Chain Parsing Server via one or more mediums including, but not limited to Wi-Fi™, Personal Area Network (PAN), Bluetooth™, NFC (near-field communication), optical or acoustic communication, or direct connection (e.g. USB, Thunderbolt, FireWire™, etc.).

Status packets generated for “push-notifications” need to be generated and sent to the device only when there are updated transactions to send. A backend cloud application may receive specific intervals of confirmations (confirmations is a bitcoin term), in some embodiments, and sends encrypted wake up signals to the wallet to sync segmented confirmations along the way to the wallet. So the wallet has a breadcrumb trail of confirmations, but only wakes-up when a backend process sends a wake-up signal to the device. The backend determines when to send those wake ups based upon an algorithm that intelligently determines when to make a breakpoint.

The synchronization method disclosed in this invention does not require encryption on the status packet, since it is all public domain information. But, a Hash value generated from a SALT value and/or with other data in the status packet may be utilized, in some embodiments, to identify any type of transmission error or data tampering. The Parsing Server could either be a cloud service, or the user's own server.

Communication (network traffic) between the Parsing Server and the device can be instantiated either by a push-notification from the Parsing Server to the device or a scheduled polling request from the device to the Parsing Server. However, to support the lowest power requirements, the device could be configured to listen for Push notifications only on a specified schedule (e.g. listen every 15-minutes or once an hour) and allow for potential clock-drift between the device and the Parsing Server by listening for a specified amount of time (e.g. listen for push notifications for 1-minute, or 2-minutes).

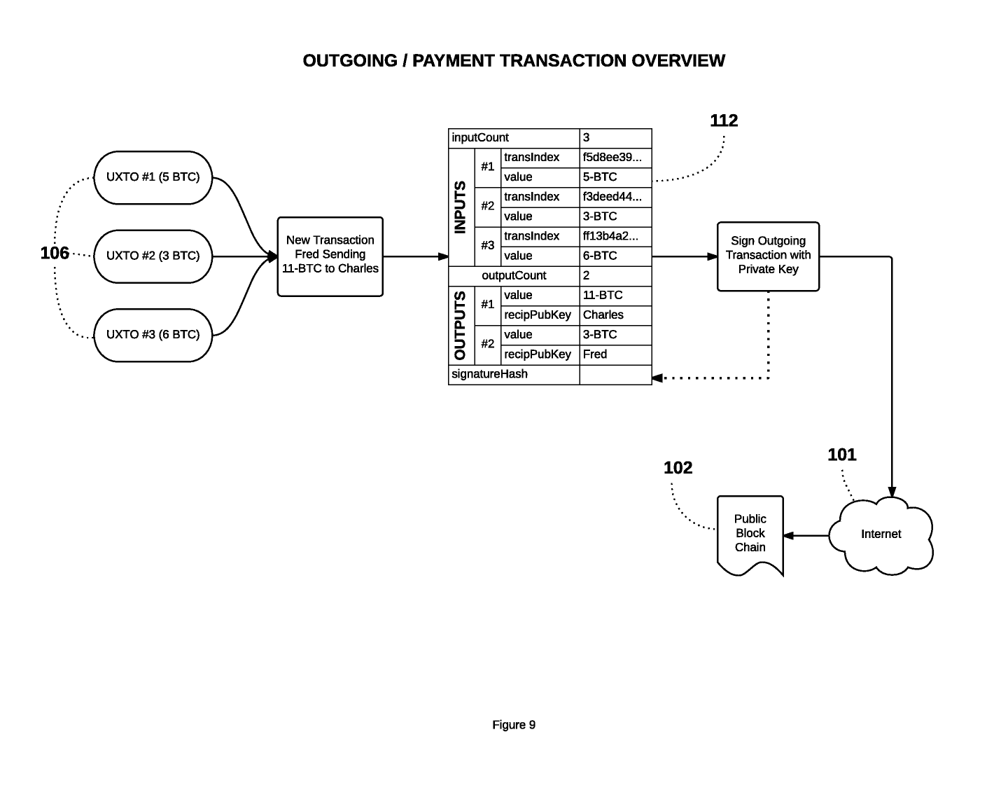

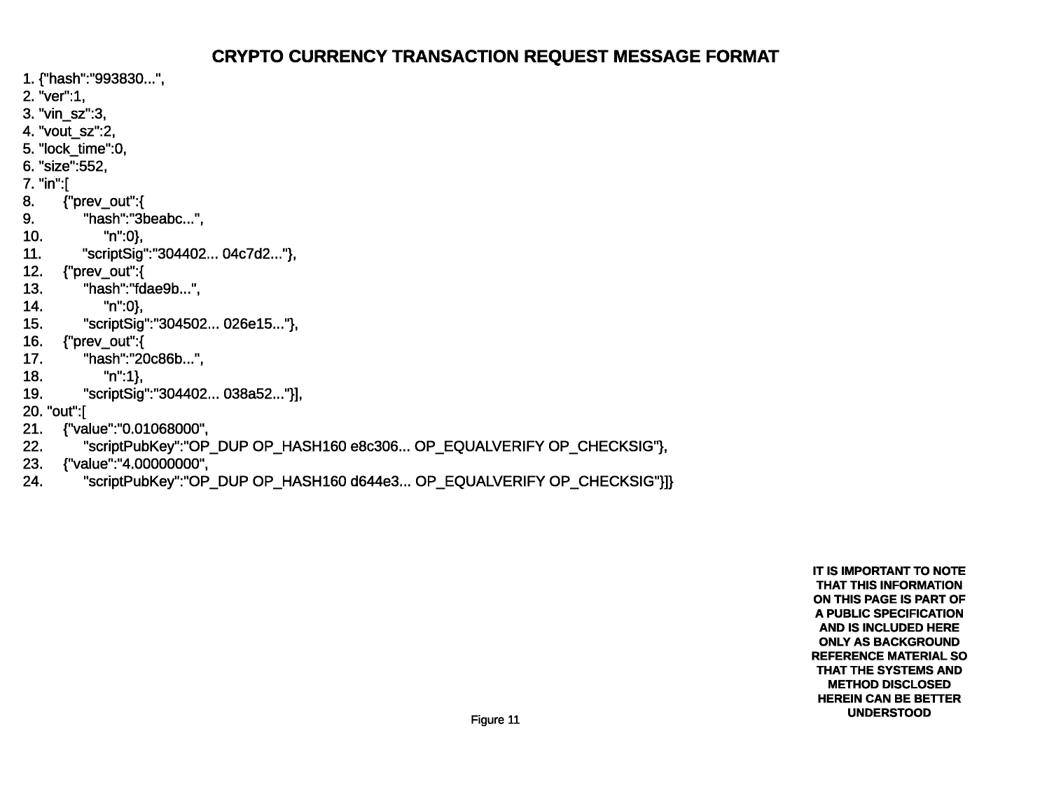

FIG. 9 outlines, for illustration purposes, an overview of the process for a new transaction generated by the crypto-currency wallet on a mobile device. The standard transaction information format (see FIG. 11) is used so that the transaction can be easily recognized and processed by the block chain workers. This transaction can be announced to the public block chain via Internet using one or more mediums including, but not limited to Wi-Fi™, Personal Area Network (PAN), Bluetooth™, NFC (near-field communication), optical or acoustic communication, or direct connection (e.g. USB, Thunderbolt, FireWire™, etc.) to an Internet-connected computer or mobile device. If multiple transmission paths are available, the present disclosed invention will select the path requiring the least amount of power to reliably transmit the transaction.

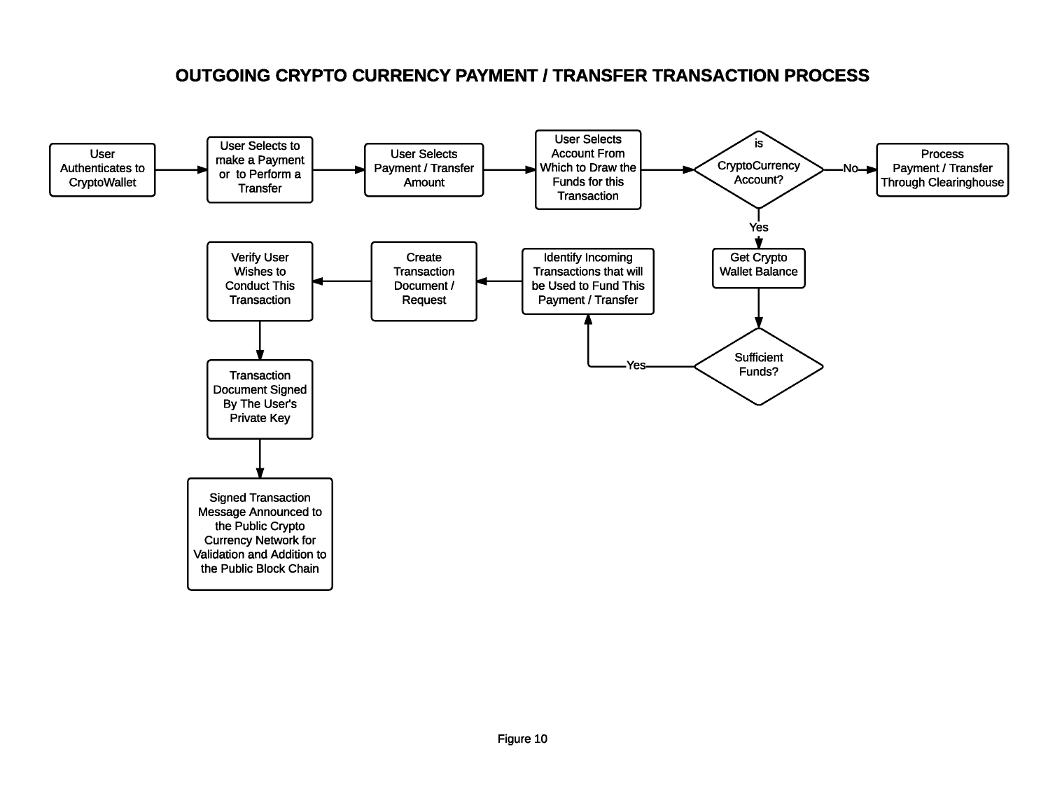

FIG. 10 shows a more detailed, non-limiting, version of the transaction creation process as an illustration of the ease in which a user may actually perform the transaction with all of the complexity of the data transmission automatically managed by the present disclosed invention.

FIG. 11 shows an abbreviated example of the information contained in the outgoing transaction data. This format is a public specification and is only included as background reference material.

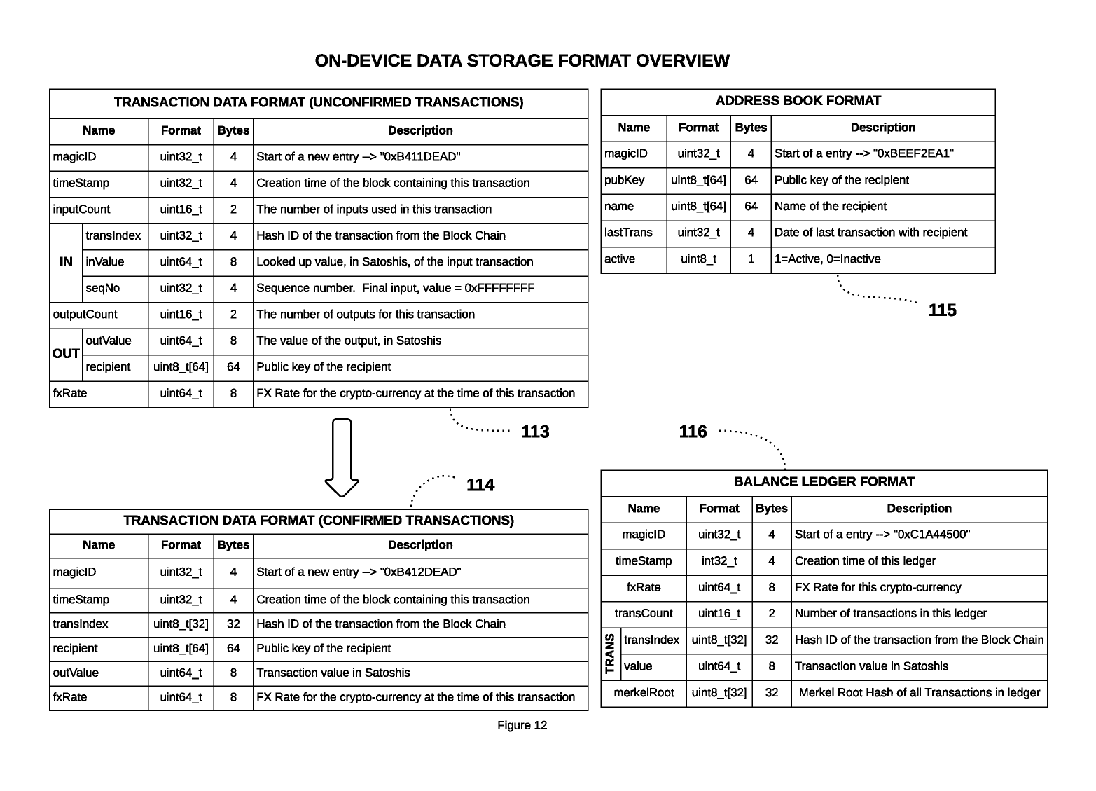

FIG. 12 provides a non-limiting example of the storage format for the data on the mobile device. The example format shown is for flat-file (no database) storage, however the same data could easily be placed into a database for easier access. It is important to note that the only potentially sensitive data is the Address Book's NAME field, which can be encrypted if configured by the user, as all of the other information can easily be obtained from the public block chain or FX-Rate (i.e., the exchange rate) lookup.

As an exemplary, non-limiting embodiment of the present invention, a user that has a Bitcoin wallet on their smart-wallet device may decide that they wish to pay for a purchase using Bitcoins. After the user authenticates to their smart-wallet, thereby unlocking it, they are able to select to use Bitcoins for a new transaction. The method and system disclosed in the present invention quickly checks when the Balance Ledger of the Bitcoin Wallet was last updated. If it has been longer than 10-minutes (the average amount of time it takes to add a new block to the block chain which commits all new transactions), the synchronization process described herein determines the best method (lowest power and most reliable) to use and then transmits a status query to the Block Chain Synchronization Server that returns a status packet. If the hash value of the status packet matches the hash vale of the Balance Ledger, the ledger is considered up to date and the user can proceed with the transaction. If the hashes do not match, the synchronization process requests an updated Balance Ledger from the Block Chain Parsing Server.

When received, the hash from the newly delivered Balance Ledger is compared to the hash from the status packet. If they match the Bitcoin Wallet is updated with the new Balance Ledger, if they do not match the ledger is re-requested up to a maximum number of retries. Once the Balance Ledger for the wallet is up to date, the user is able to select the amount of the transaction. If the user has enough Bitcoins, they are allowed to execute the transaction which creates the transaction document. This transaction document is then transmitted to the bitcoin network for inclusion in the block chain via one or more transmission methods (e.g. Wi-Fi™, Bluetooth™, LoRa™, NFC, P2P (pere2peer), etc.).

Once the transaction has been processed by the bitcoin network and added to the block chain, the transaction is considered to be confirmed (this confirmation can take up to 10-minutes or longer). Once the Block Chain Parsing Server sees that there have been two or more confirmations (this number is user configurable), it sends a push notification to the user's smart-wallet which triggers the synchronization process to update the Outgoing Transaction information, shedding excess information that no longer needs to be stored locally on the device.

In summary, the systems and methods disclosed herein minimize the amount of data that needs to be synchronized to the crypto-currency wallet on a mobile device, a wearable device, or another device, minimizing the storage requirements of that data on the device, and relies upon the confirmation mechanisms built into the public specification for the block chain thereby removing the need to validate transactions locally. These benefits, in conjunction with the smart management of data transmission and reception paths/modes, directly result in the ability to keep a crypto-currency wallet on a smart device up to date and execute transactions with minimal impact to the devices battery life and network bandwidth requirements while using a very small amount of the mobile device's CPU processing power. All these items are accomplished without reducing the security of the crypto-currency wallet's private key

Further details and concepts related to crypto-currency can be found in commonly-owned and related patent application entitled, Electronic Crypto-Currency Management Method and System, assigned application Ser. No. 15/225,780 (Attorney docket number 12188-023) and filed on Aug. 1, 2016, which is incorporated herein by reference.

Although the acronym UXTO is used herein to designate unspent transaction outputs, some reference sources may use the acronym UTXO instead.

An exemplary system for implementing the various software aspects of the invention includes a computing device or a network of computing devices. In a basic configuration, computing device may include any type of stationary computing device or a mobile computing device. Computing device typically includes at least one processing unit and system memory. Depending on the exact configuration and type of computing device, system memory may be volatile (such as RAM), non-volatile (such as ROM, flash memory, and the like) or some combination of the two. System memory typically includes operating system, one or more applications, and may include program data. Computing device may also have additional features or functionality. For example, computing device may also include additional data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules or other data. System memory, removable storage and non-removable storage are all examples of computer storage media. Non-transitory computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by computing device. Any such computer storage media may be part of device. A computing device may also have input device(s) such as a keyboard, mouse, pen, voice input device, touch input device, etc. Output device(s) such as a display, speakers, printer, etc. may also be included. Computing device also contains communication connection(s) that allow the device to communicate with other computing devices, such as over a network or a wireless network. By way of example, and not limitation, communication connection(s) may include wired media such as a wired network or direct-wired connection, and wireless media such as acoustic, RF, infrared and other wireless media.

Computer program code for carrying out operations of the invention described above may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. A code in which a program of the present invention is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD). The present invention can be configured for use in a computer or an information processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general purpose computer, but rather the special purpose computer programmed to perform the disclosed algorithm.

A general purpose computer, or microprocessor, may be programmed to carry out the algorithm/steps of the present invention creating a new machine. The general purpose computer becomes a special purpose computer once it is programmed to perform particular functions pursuant to instructions from program software of the present invention. The instructions of the software program that carry out the algorithm/steps electrically change the general purpose computer by creating electrical paths within the device. These electrical paths create a special purpose machine for carrying out the particular algorithm/steps.

Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

While the invention has been described with reference to preferred embodiments, it will be understood by those skilled in the art that various changes may be made and equivalent elements may be substituted for elements thereof without departing from the scope of the present invention. The scope of the present invention further includes any combination of the elements from the various embodiments set forth. In addition, modifications may be made to adapt a particular situation to the teachings of the present invention without departing from its essential scope. Therefore, it is intended that the invention not be limited to the particular embodiment disclosed as the best mode contemplated for carrying out this invention, but that the invention will include all embodiments falling within the scope of the appended claims.

What is claimed is:

1. A method for synchronizing a crypto-currency balance ledger stored on a device with data from the associated public crypto-currency block chain, the method comprising:
a. receiving from the public block chain data related to incoming transactions as limited to unspent transaction outputs (UTXOs);
b. receiving from the public block chain data related to outgoing transactions that are conducted within a predetermined time frame as determined by a user; and
c. determining whether the data received matches a current balance ledger as stored on the device; and if a match is not indicated updating the current balance ledger to generate an updated balance ledger.

2. The method of claim 1 wherein the data comprises less than complete transaction information for a transaction having less than a predetermined number of confirmations.

3. The method of claim 1 wherein the data comprises less than complete transaction information for a transaction having more than a predetermined number of confirmations.

4. The method of claim 1 a user determining the predetermined number of confirmations.

5. The method of claim 1 further comprising implementing a hashing value in the data for use to detect data corruption and tampering.

6. The method of claim 1 wherein the device comprises a mobile device, a wearable device, or a crypto-currency wallet or a smart wallet.

7. The method of claim 1 wherein the device comprises communication components capable of communicating via near field, Wi-Fi, Bluetooth, LoRa, private area network, optical, acoustic, pere2peer, point2point communications techniques, the communications components for use in receiving data related to the incoming and outgoing transactions.

8. The method of claim 1 wherein the step of determining comprises comparing a Merkel Root Hash of the current balance ledger with a Merkel Root Hash of the data received in a status packet.

9. A system for providing formatted data to a mobile or wearable device via one or more communication paths:
a first component for receiving from the public block chain data related to incoming transactions as limited to unspent transaction outputs (UXTOs); and
a second component for receiving from the public block chain data related to outgoing transactions that are conducted within a user defined time frame;
a third component for determining whether the data received matches a current balance ledger as stored on the device; and
if a match is not indicated a fourth component for updating the current balance ledger to generate an updated balance ledger.

10. The system of claim 9 wherein the first component utilizes either data polling or push notifications.

11. The system of claim 9 the data in a format using hashes to determine data integrity.

12. The system of claim 9 wherein the communication path is dynamically selected.

13. The system of claim 9 wherein the communications paths comprise Wi-Fi™, Bluetooth™, LoRa, optical transmission, NFC, or direct physical connection.

14. The system of claim 9 wherein the communication path comprises a communication path that is selected from a user-defined prioritization of all available communications paths.

15. The system of claim 14 wherein the communication path comprises a plurality of communication paths.

16. The system of claim 9 wherein a format of the data comprises a flat-file format or a database format.

17. The system of claim 9 wherein the data incorporates a Merkel Tree Hash or a user-configurable cryptographic function.

18. The system of claim 9 wherein the data is encrypted or presented in plain-text.

19. A method for announcing new transactions to the crypto-currency network for inclusion in the block chain, the method comprising: implementing a predetermined transaction fee, payment of which ensures inclusion of the transaction in the block chain in a timely manner; paying the transaction fee; and including the transaction in the block chain.

20. The method of claim 19 wherein a communication path to reach the Internet comprises one or more of Wi-Fi™, Bluetooth™, LoRa, optical transmissions, NFC, pere2peer, point2point, or direct physical connection.
